(19) United States
(12) Patent Application Publication
(10) Pub. No.: US 2020/0362977 A1
(43) Pub. Date: Nov. 19, 2020

(54) REMOTE HOSE VALVE CONTROL

(71) Applicant: TAILAI TING, POMONA, CA (US)

(72) Inventor: TAILAI TING, POMONA, CA (US)

(21) Appl. No.: 16/416,049

(22) Filed: May 17, 2019

(51) Int. Cl. F16K 31/02

(52) U.S. Cl. CPC F16K 31/02

(57) ABSTRACT

A remote hose valve control includes a remote valve connected between faucet and hose, and equipped with DC 12V battery. To prevent huge water pressure inside hose, the remote valve has to connect to faucet. On the other side of hose where the nozzle is placed, an on/off switch is equipped to control remote valve. The remote hose valve control can not only save time, but also prevent water leaking and damage to hose, allowing user to perform watering tasks conveniently and safely without producing much waste.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to remote hose valve control, and more particularly to enable user to remotely control hose valve using switch on hose.

### Description of Related Arts

When performing watering tasks, people handling hose nozzle usually work far away from faucet valve, depending on the length of hose and how far they need to reach to perform such tasks. There are a lot of time wasted when they need to walk back and forth to switch on or off valve. Additionally, there is potentially large amount of water wasted if they rather keep the valve on.

Nowadays, there are a variety of hose nozzles and sprayers that people can choose, and the most common one is equipped with on/off switch at the nozzle, which can control water from spraying out. The current design of the hose nozzle on the market resolves the problem of having to go back and forth to faucet valve. The hose nozzle itself is equipped with a valve and people can easily control at their convenience. However, the current design posts many problems mainly on hose. When people switch off valve at hose nozzle, this will create huge water pressure inside hose. Unlike faucets, hoses cannot hold as much water pressure, they are likely to be damaged or explode due to large water pressure inside, shortening lifespan of hoses. Eventually, there will be leakage and tremendous amount of water will be wasted.

### SUMMARY OF THE PRESENT INVENTION

A main object of the present invention is a remote valve installed and connected to the faucet, along with an on/off switch near the hose nozzle to control hose valve.

Another advantage of the invention is to control the remote valve, which is connected to the faucet and equipped with battery, using on/off switch near hose nozzle.

Another advantage of the invention is to control the remote valve installed at the faucet, thereby prevents water being left inside hose and causes huge water pressure.

Another advantage of the invention is to control the remote valve installed at the faucet, thereby prevent hose explosion or leakage due to water pressure inside hose.

Another advantage of the invention is to control the remote valve installed at the faucet, thereby prevent waste of water if hose is left unattended.

Another advantage of the invention is that the installed remote valve at the faucet comes with DC 12V battery as power supply.

Another advantage of the invention is that the DC 12 V battery of installed remote valve at the faucet can be charged by DC adapter.

Another advantage of the invention is that the DC 12 V battery of installed remote valve at the faucet can be charged by water flow.

Additional advantages and features of the invention will become apparent from the description which follows, and may be realized by means of the instrumentalities and combinations particular point out in the appended claims.

### BRIEF DESCRIPTION OF THE DRAWINGS

FIG. 1 is a perspective view of the remote hose valve control in the preferred embodiment of the present invention.

### DETAILED DESCRIPTION OF THE INVENTION

The following description is disclosed to enable any person skilled in the art to make and use the present invention. Preferred embodiments are provided in the following description only as examples and modifications will be apparent to those skilled in the art. The general principles defined in the following description in the following description would be applied to other embodiments, alternatives, modifications, equivalents, and applications without departing from the spirit and scope of the present invention.

According to the preferred embodiment, the remote hose valve control comprises a remote valve that comes with DC 12 V battery and is installed at the faucet, along with an on/off switch near hose nozzle.

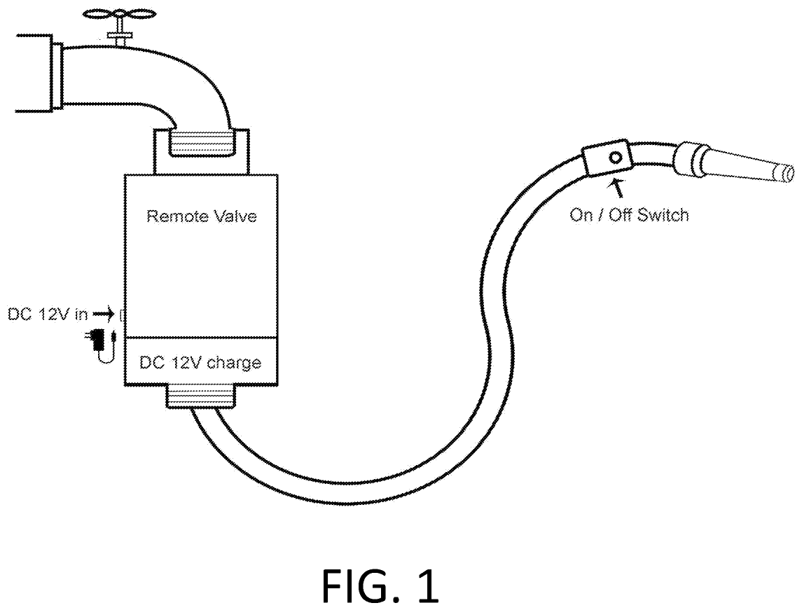

FIG. 1 is a perspective view of the remote hose valve control in the preferred embodiment of the present invention. The preferred embodiment of the present invention of the remote hose valve control further demonstrates that the remote valve with battery is installed and connected to faucet, along with an on/off switch near hose nozzle, wherein a user is able to switch off remote valve when not in demand. One side of the remote valve is connected with faucet, and the other side is connected with a hose, at the other end of the hose where the nozzle is placed, consists of an on/off switch.

The remote hose valve control can be used when performing watering tasks. When there is a need to switch off valve distantly, one can operate the on/off switch near the hose nozzle. The on/off switch then controls the remote valve, which is connected between faucet and hose, and comes with DC 12V battery. There will be no water pressure inside hose when switching off valve, thereby prevents hose from being damaged. There are two ways to charge battery in remote valve, one way is by DC 12V power supply, and another way is by water flow.

A main objective of the invention is to control remote valve using an on/off switch to save time and water, as well as to prevent damage to hose. With the remote hose valve control, not only water can be saved, but also lifespan of hose can be prolonged.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1. A remote hose valve control with on/off switch, comprising:
A remote valve connected to faucet and hose; and
a DC 12V battery at remote valve; and
a on/off switch near hose nozzle.

2. The remote hose valve control, as recited in claim 1, wherein said system comprises a remote valve connected to faucet on one end, and connected to hose on the other end.

3. The remote hose valve control, as recited in claim 1, wherein said remote valve comprises a battery and can be charged by either DC 12V power supply or water flow.

4. The remote hose valve control, as recited in claim 1, wherein said system comprises an on/off switch near the hose nozzle, and can be used to control remote valve.
